(19) United States
(12) Patent Application Publication
(10) Pub. No.: US 2013/0204783 A1
(43) Pub. Date: Aug. 8, 2013

(54) SYSTEM AND METHOD FOR PERFORMING REMOTE CHECK PRESENTMENT (RCP) TRANSACTIONS BY A CHECK CASHING COMPANY

(71) Applicant: ACE CASH EXPRESS, INC., Irving, TX (US)

(72) Inventors: Allen Klose, Dallas, TX (US); Joe Edwards, Colleyville, TX (US); John Maguire, Coppell, TX (US); Jerald Horner, Flower Mound, TX (US); Alex Keechle, Dallas, TX (US); Susy Darmawi, Irving, TX (US); David Minter, Littleton, CO (US)

(73) Assignee: ACE CASH EXPRESS, INC., Irving, TX (US)

(21) Appl. No.: 13/736,464

(22) Filed: Jan. 8, 2013

Related U.S. Application Data
(60) Provisional application No. 61/584,632, filed on Jan. 9, 2012.

(51) Int. Cl. G06Q 20/10

(52) U.S. Cl. CPC G06Q 20/108
USPC 705/42

(57) ABSTRACT

A system and method of handling remote check presentment (RCP) of a check may include receiving, from a computing device of a user, RCP data at a computing device, such as a computer server. A determination, by the computing system, of a risk factor associated with the RCP data may be made. In response to determining the risk factor associated with the RCP data, a determination, by the computing system, as to how to make cash available to the user prior to passing the check for clearance through a traditional check clearing process may be performed. The cash may be made available as determined to the user prior to passing the check for clearance through the traditional check clearing process.

### RELATED APPLICATIONS

This Application claims priority to co-pending U.S. Provisional Patent Application Ser. No. 61/584,632 filed on Jan. 9, 2012, the contents of which are hereby incorporated by reference in their entirety.

### BACKGROUND

Banking has evolved considerably with the evolution of technology. Banking used to be handled by cash transactions, but evolved dramatically with the creation of credit and debit cards. Banking significantly advanced with the creation of automatic teller machines (ATMs), which allowed banking customers to deposit and access cash 24 hours a day via the ATMs. More recently, with the advancement in telecommunications and personal electronic devices, Internet and mobile banking has evolved. While Internet and mobile banking have provided customers with the ability to perform certain banking functions, such as receiving balances, reviewing transactions, and so on, other functions, such as depositing checks and accessing cash, has been limited. More recently, however, mobile banking has advanced such that banking customers can use smart phone or scanner technology to perform remote deposit capture (RDC) to perform check depositing by using a camera on the smart phone or a scanner attached to a personal computer to capture an image of a check and, using a mobile banking application operating on the electronic device, deposit the check into a bank account by submitting the check image.

Check cashing companies provide services that are generally not provided by banking. Check cashing companies are able to cash checks and provide a customer with instant cash prior to clearance of the check through the traditional banking system. Check cashing services absorb the risk of a check not clearing, but to offset the risk, the check cashing companies charge a fee for their services. To minimize risk, check cashing companies generally use a number of risk mitigation techniques, such as requiring customers to visit a branch office, reviewing a maker of the check, monitor consistency of customers in cashing checks, and so forth. As understood in the art, check cashing companies use human interaction to help assist in minimizing risk for cashing checks that will ultimately not clear.

Despite remote deposit capture becoming available in the banking industry, there are still a number of limitations are not addressed by remote deposit capture, such as the time it takes for checks to clear after making a deposit and the ability to instantly draw or access cash after making the deposit Moreover, the use of remote deposit capture by check cashing companies has heretofore not been used since, as described above, check cashing companies use certain techniques to personally know and/or examine customers prior to cashing checks, as a result of the check cashing companies having certain risks that banks do not otherwise have.

### SUMMARY

The principles to the present invention provide for check cashing companies with the ability to use remote deposit capture (RDC) within a process herein defined as remote check presentment (RCP). Check cashing companies may utilize RCP transaction capabilities in providing check cashing services for its customers. Business rules are applied to RCP transactions made by customers so as to minimize risk of the RCP check cashing transactions being invalid and/or unlawful. Depending upon results of processing an RCP transaction, a customer is able to receive proceeds from the submitted RCP item prior to the transaction being cleared by the traditional banking system. Proceeds may be disbursed from a storefront of the check cashing company, deposited into his or her account, be loaded on a debit card, or otherwise.

The principles of the present invention further provide for a centralized RCP data repository that may be used by check cashing companies and other organizations to identify checks that have been cashed via an RCP transaction prior to a traditional check clearing process as performed by the banking system. The centralized RCP data repository may be queried by the RCP transaction process or manually to prevent more than one presentation of a check to the banking system.

One embodiment of a method of handling the remote check presentment of a check may include receiving, from a computing device of a user, RCP data at a computing device, such as a computer server. A determination, by the computing device, of a risk factor associated with the RCP data may be made. In response to determining the risk factor associated with the RCP data, a determination, by the computing device, as to how to make cash available to the user prior to passing the check for clearance through a traditional check clearing process may be performed. The cash may be made available as determined to the user prior to passing the check for clearance through the traditional check clearing process.

One embodiment of a system for providing remote check presentment transaction reporting may include a storage unit configured to store a data repository that includes RCP transaction data. A computing device may be in communication with the storage unit, and be configured to receive a request to query the data repository. The request may include check data to compare to the RCP transaction data, where the check data may include information that uniquely identifies the check. The data repository may be queried using the check data A determination may be made as to whether the data repository includes RCP transaction data that matches the check data. A response that indicates whether the RCP transaction data includes a match of the check data may be communicated. By providing for the RCP transaction reporting, multiple payments for multiple presentments of the same check may be prevented.

### BRIEF DESCRIPTION

Illustrative embodiments of the present invention are described in detail below with reference to the attached drawing figures, which are incorporated by reference herein and wherein:

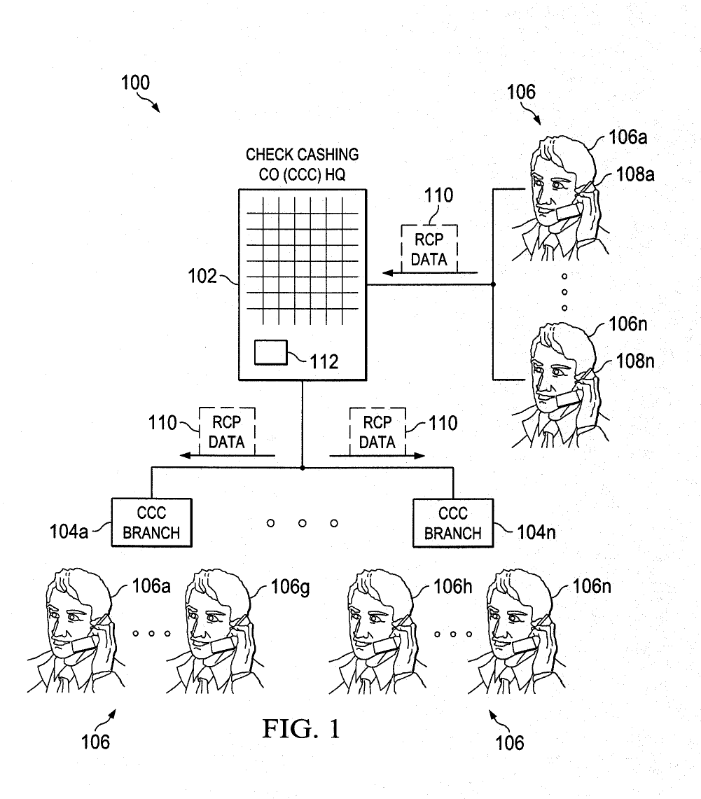

FIG. 1 is an illustration of an illustrative check cashing company operation with customers with addition of RCP transactions with customers;

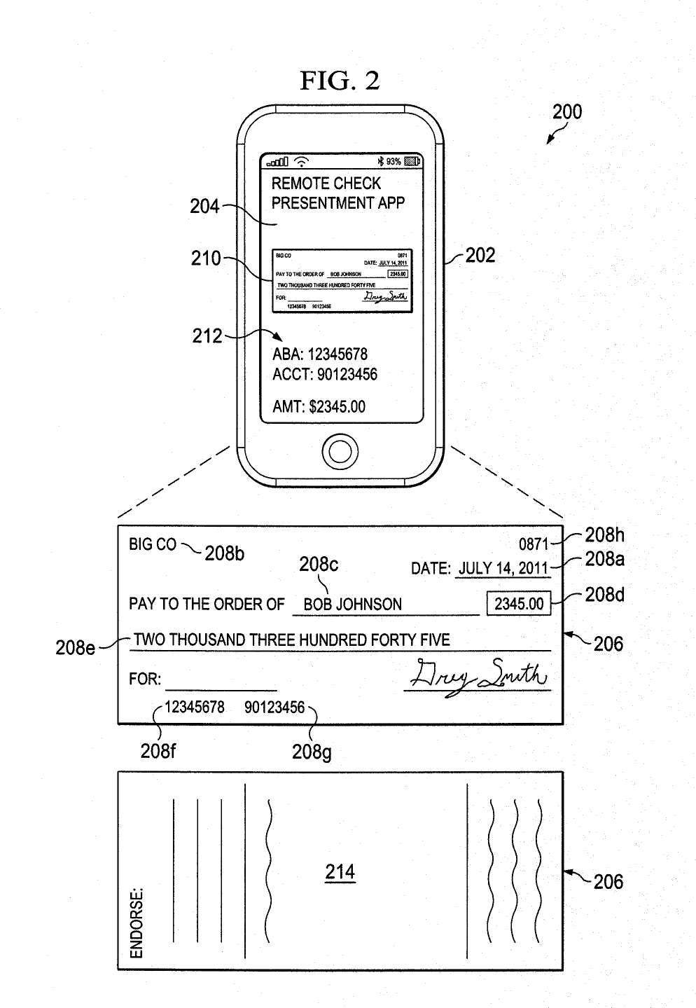

FIG. 2 is an illustration of a check being imaged by an RCP application for use with a check cashing company operating on a computing device, such as a smart phone, personal computer or tablet computer;

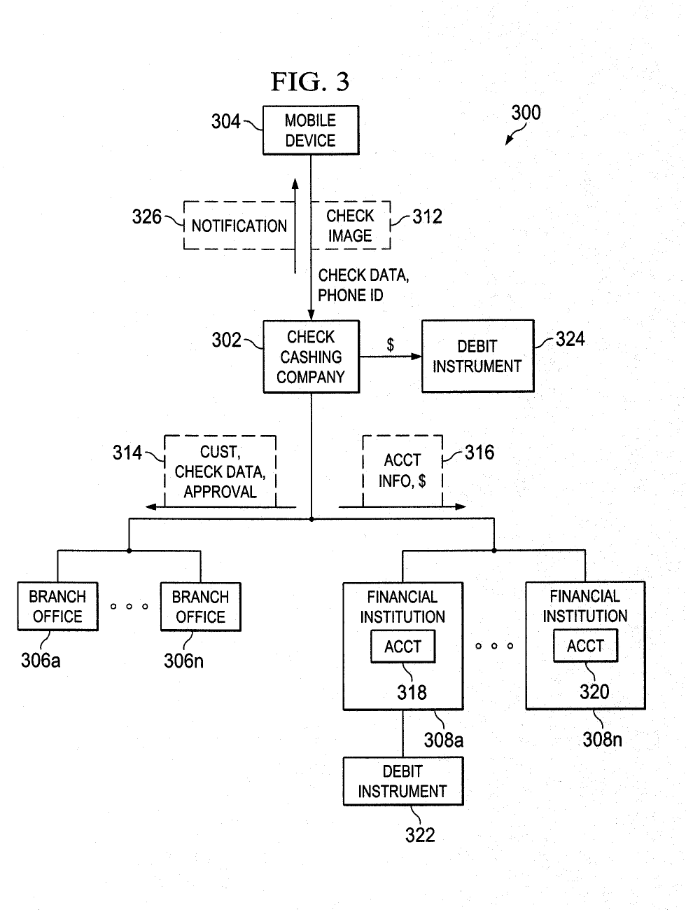

FIG. 3 is a block diagram of an illustrative check cashing company and communications of an RCP transaction from a computing device of a customer with resulting communications of data and money as directed by the check cashing company;

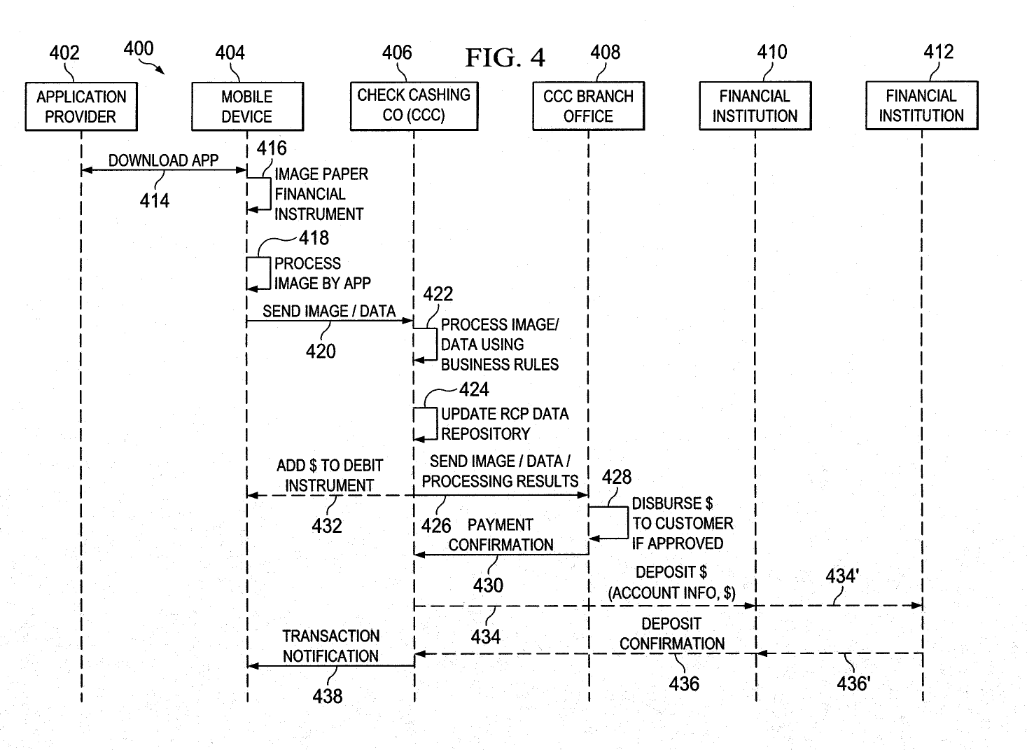

FIG. 4 is an interaction diagram showing communications and processing of RCP transactions by a check cashing company;

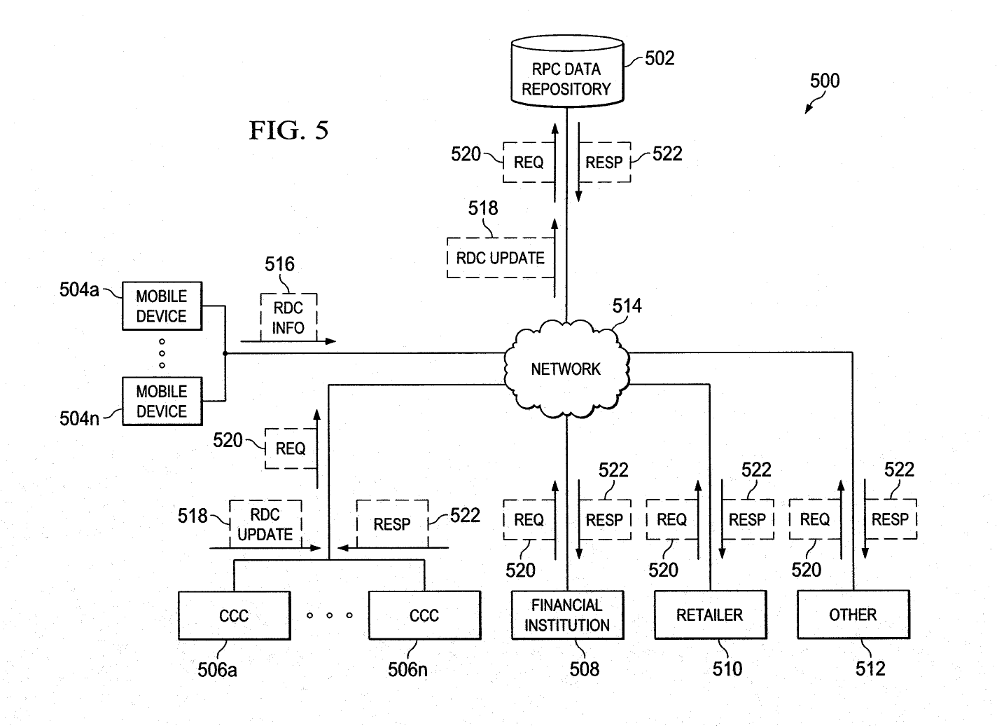

FIG. 5 is a block diagram of an illustrative network in which an RCP data repository that is centralized for use by check cashing companies, financial institutions, such as banks, retailers, and any other organization, that receive checks for payments of goods and services;

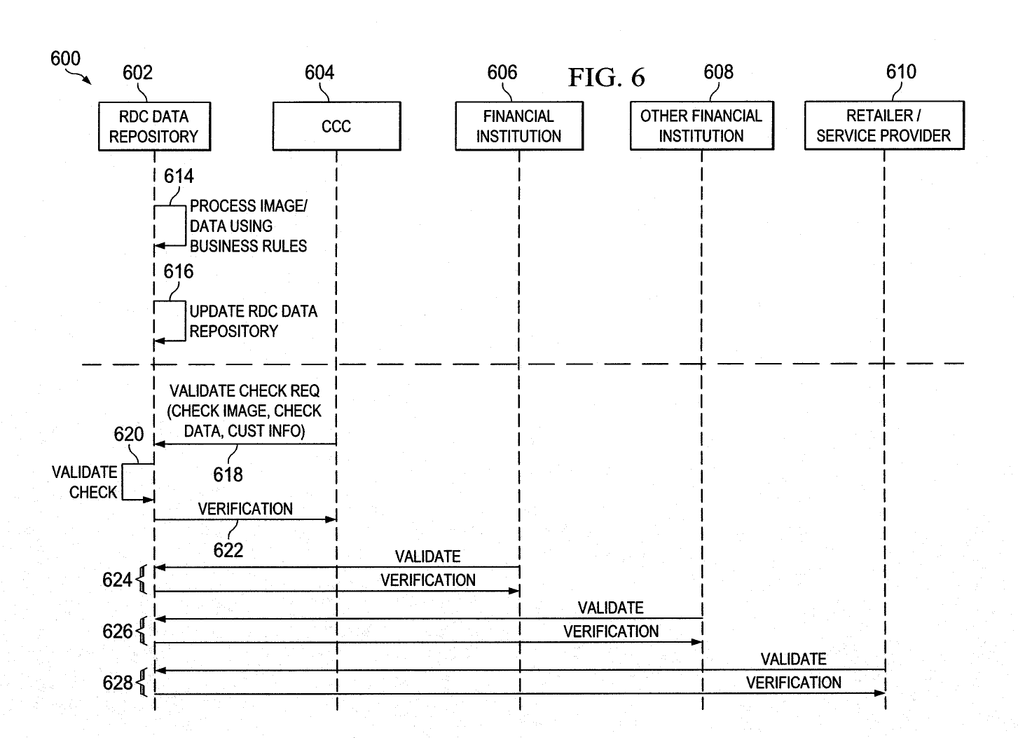

FIG. 6 is an interaction diagram showing processing and communications of RCP data with respect to the RCP data repository and entities that communicate with the RCP data repository to validate checks that may have been processed by a check cashing company;

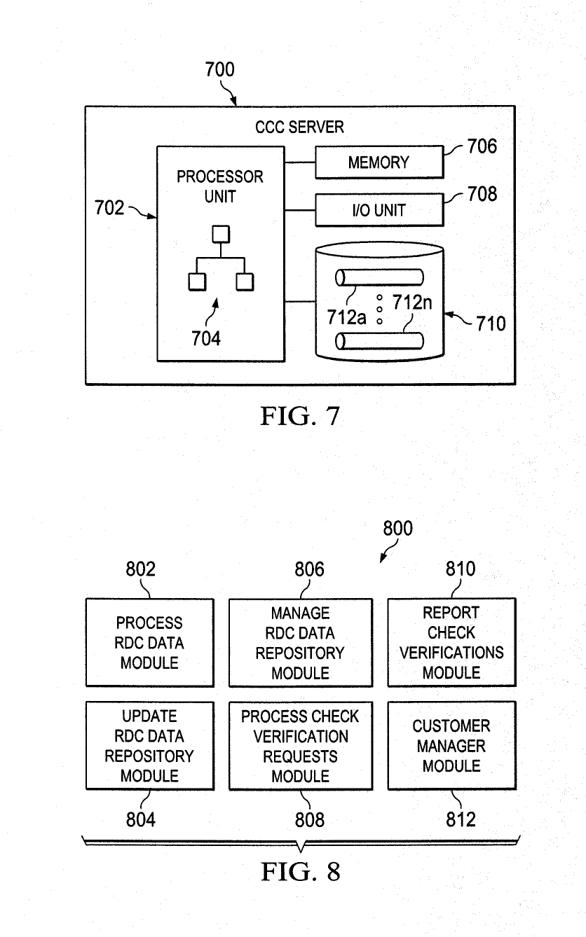

FIG. 7 is a block diagram of an illustrative check cashing company server that is configured to perform check cashing company processing on RCP transactions for check cashing;

FIG. 8 is a block diagram of illustrative software modules that are executed by the check cashing company server of FIG. 7 to perform check cashing company processes, for verifying RCP transactions;

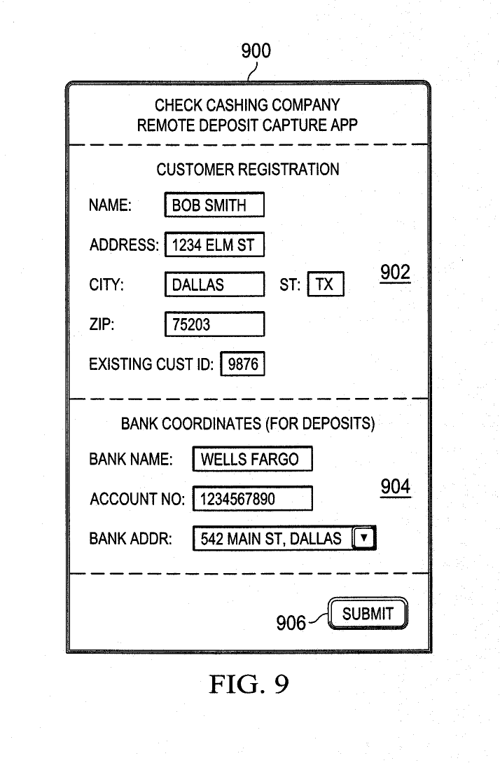

FIG. 9 is a screen shot of an illustrative RCP software application for performing a customer registration;

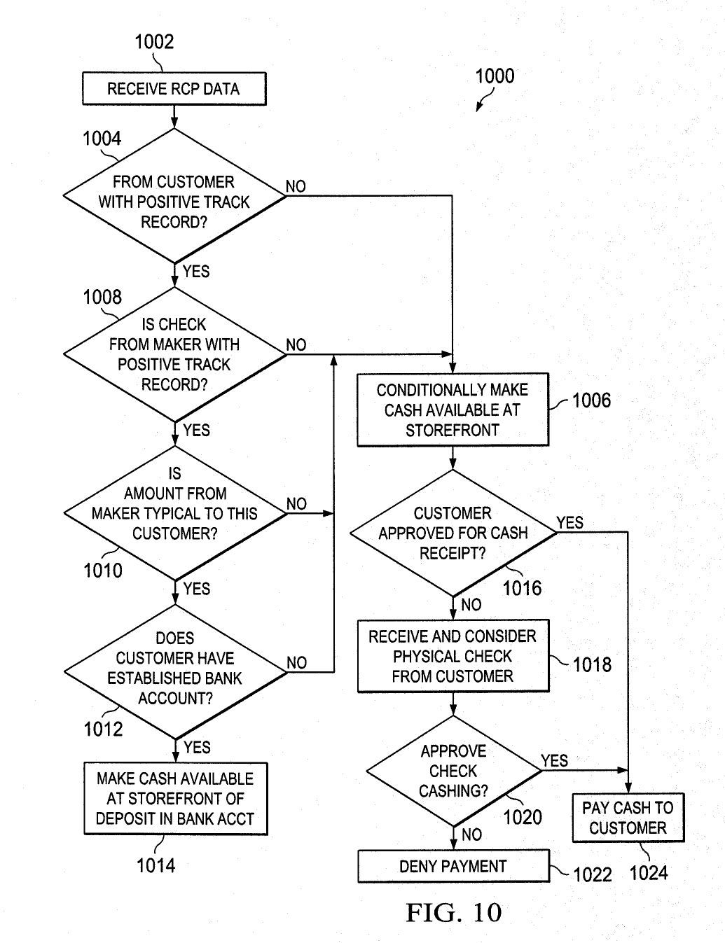

FIG. 10 is a flow diagram of an illustrative process for assessing customer risk by a check cashing company so as to determine how to make cash available to a customer based on a determined risk factor; and

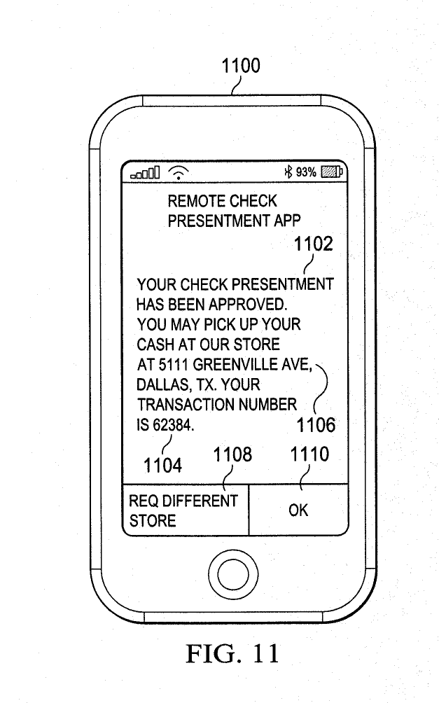

FIG. 11 is an illustration of an illustrative computing device, in this case a mobile telephone, that is executing a remote check presentment app and showing a response to a check presentment.

### DETAILED DESCRIPTION

With regard to FIG. 1, an illustration of an illustrative check cashing environment 100 that includes a check cashing company (CCC) headquarters 102 with individual check cashing company branches 104a-104n (collectively 104). As understood in the art, the check cashing company branches 104 have traditionally had customers 106a-106n (collectively 106) bring checks (not shown) into the branches 104 to get cashed immediately without having to wait for the checks to be processed and cleared through conventional check clearing process of the traditional banking systems. Because the check cashing company has a significantly higher level of risk than a check processed by the check clearing processes of the traditional banking system, the check cashing company charges a fee to the customers 106 for cashing the checks. The amount of the fee may vary depending on a number of business rules, including state and local regulations, that are applied by the check cashing company based on the individual customers 106, makers of the checks, checks themselves, and so forth.

In accordance with the principles of the present invention, the customers 106 may utilize computing devices 108a-108n (collectively) that include cameras or scanners capable of imaging checks. The computing devices 108 may be smartphone devices, personal computers, tablet computers, or any other electronic devices capable of capturing a check image executing software applications or apps to perform the same or similar functionality described herein. In one embodiment, a remote check presentment app may be one provided by the check cashing company 102 or affiliate thereof (e.g., software developer) that allows customers 106 to image a check and communicate RCP data 110. For example, the RCP data 110 may include routing/ABA number, account number, amount of check, etc., that may be parsed from the imaged check by a computing device, such as computing device 108a or computing system 112. In an alternative embodiment, the RCP data 110 may be data that is manually entered into a computing device. The RCP data 110 may be inclusive of and derived from the imaged check. The RCP data 110 may be communicated to the computing system 112, which may be a server, being operated by the check cashing company 102. It should be understood that the computing system 112 may be one or more computers and be operating at the check cashing company's headquarters or remotely located while being accessible by the check cashing company via a communications network, such as the Internet. In one embodiment, the RCP data 110 may be communicated to or accessible by one or more of the check cashing company's branches 104 depending upon business rules that are applied to the RCP data 110 in association with respective customers 106.

With regard to FIG. 2, an image capturing process 200 of a computing device 202, for illustrative purposes a smartphone is depicted, executing an RCP app 204 is shown. The process 200 may include a user operating the RCP capture app 204 being executed by the computing device 202 and imaging a paper check 206. The paper check 206 is shown to include a number different items 208a-208h (collectively 208). The items 208 on the paper check that may be used in performing a check verification may include (i) numeric amount of check 208d, (ii) ABA routing number 208f, (iii) account number 208g, and (iv) check number 208h. The other items, including (i) date 208a, (ii) maker 208b, (iii) payee 208c, and (iv) alpha-written amount 208e, may be imaged and converted into text, but not used in performing the check verification using an automated process. Of course, should a manual process be used either as primary or secondary check verification, then the other items may be utilized in that manual process. As the computing device 202 includes an imaging system (e.g., camera), the computing device 202 may take an image 209 of the check 206 of both sides of the check 206 for processing, as described herein.

In one embodiment, the remote check presentment app 204 may be configured to parse and extract the imaged information 208 from the check, and to display a check image 210 and parsed check information 212. A user can view the imaged check and parsed information prior to communicating the image check 210 and parsed information 212 (RCP transaction data) to the check cashing company. In addition, the remote check presentment app 204 may enable a user to manually correct information or add check information should the parsed information 212 be incorrect or missing information as a result of the parsing functionality not producing a result for one or more of the items 208 of the check. Parsing may include correcting a check image using image processing, performing optical character recognition (OCR), and, as understood in the art, associating the recognized characters with a particular data fields, such as ABA number and amount of check. It should be understood that, as previously described, rather than the RCP app 204 performing the parsing, that the check cashing company's computing system may perform the parsing of the imaged check and report that the imaged check was properly captured and delivered by the RCP app 204 to the customer or user. It should further be understood that the RCP app 204 and computing system of the check cashing company may individually perform the parsing and results of the parsing may be compared so as to ensure accuracy of the information 212 derived from the imaged check 210.

As further shown in FIG. 2, a reverse side 214 of the check 206 is provided. As understood in the art, imaging of the reverse side 214 of the check 206 is to be performed when the user images the check via the remote check presentment app. As further understood in the art, the reverse side 214 of the check 206 includes an endorsement by the recipient of the check 206. The imaging of the reverse side 214 of the check 206 is for visual verification purposes, and unlikely to be used for parsing and data creation, as is performed on the front side of the check 206. In one embodiment, the remote check presentment app may provide visual and/or audio instructions to the user when imaging the check 206 to image both the front and reverse sides of the check 206. In one embodiment, to assist the remote check presentment app, the remote check present app may prompt the user to type or verbally enter specific items of the check, such as amount 208d. By doing so, additional confirmation may be made for use in performing either or both automatic and manual check verification.

With regard to FIG. 3, an environment 300 in which a check cashing company 302 allows for a computing device 304 of a customer to perform RCP transactions with the check cashing company 302 is shown. As previously described, the check cashing company 302 includes branch offices 306a-306n (collectively 306) in which customers who performed RCP transactions may go to receive cash from checks that were remotely imaged and submitted to the check cashing company 302. The check cashing company 302 may further have relations and communications with financial institutions 308a-308n (collectively 308), where the financial institutions 308 may include banks, brokerage houses, credit unions, or other financial institutions, as understood in the art.

In operation, a customer of the check cashing company 302 may use a computing device 304 executing an RCP application (not shown) to image a check. The RCP application may collect the check image and parse the check image to produce check data In communicating with the check cashing company 302, the computing device 304 may communicate RCP information or data 312, which may include a check image (both front and back of the check), check data (e.g., routing number/ABA, account number, check number, and amount of check), phone identifier and/or computing device identifier, customer identifier, or any other information associated with the check, customer, or computing device. The check cashing company 302, in response to receiving the RCP information 312, may perform business rules on the RCP information 312 to determine a risk factor in order to determine whether to cash the check, where and/or how to disburse cash for the check, or otherwise. More specifically, a variety of verification criteria may be applied to the check image, check data, customer data, telephone identifier (ID), etc., in order to determine that the check is valid, that the check is intended for the customer, that the maker of the check is valid, and so forth. Furthermore, one or more risk assessments may be made so as to determine option(s) that the customer has with receiving and/or depositing money from the check, such as whether the customer is to receive the check at a branch office 306, deposit the money in one of the financial institutions 308, or otherwise, for example. In one embodiment, the check cashing company deposits the check into an account of the check cashing company, and the proceeds of the check may thereafter be deposited into the customer's account. To minimize risk exposure, the check cashing company may hold the proceeds of the check in response to determining that a risk above a threshold value exists after assessing the customer and/or check, as described herein.

In response to the RCP data being processed by the check cashing company 302 and determining that the check bears high risk (e.g., risk factor above a certain threshold value), the customer may be directed to visit a branch office 306 of the check cashing company 302 for the check to be evaluated and a decision to be made as to whether the check should be cashed. The RCP information or data 314, which may include customer information, check data, check image, approval, requirements for the customer to provide to a teller at a branch office 306, or other information, may be communicated to or accessible by the branch offices 306. In one embodiment, geographic coordinate information, such as global positioning information, may be utilized to determine which branch office(s) are local to the customer and communicated to the user along with a transaction or confirmation number for the customer to present at the storefront. Alternatively, the RCP information 314 may be communicated to or accessible by a particular branch office associated with or located near the customer. Still yet, a database with customer information may include local storefront or branch office that the customer typically visits. If, however, the check cashing company 302 determines that the RCP information bears low risk (e.g., risk factor below a certain threshold level) as a result of applying certain business rules to the RCP information 314, then cash may be deposited in a particular account at a bank or other financial institution prior to the check being processed by the traditional banking system. As shown, cash may be communicated and deposited to either or both accounts 318 and 320 of the customer in the financial institutions 308. In the case of the customer having a debit instrument 322, such as a debit card, with the financial institution 308a, for example, then the customer is to have access to the cash deposited in the account 318 once the cash is posted in the account 318 for the customer, thereby avoiding a typical holding period before cash is posted to an account and made available to the customer. In an alternative scenario, if the check cashing company 302 provides a debit instrument 324 that a customer may use for accessing cash that is provided upon a check being cashed either in the store or through a RCP transaction, then the cash may be deposited into an account established by the check cashing company 302 within a financial institution, such as the financial institution 308a.

Upon completion of the transaction, a notification 326 may be communicated from the check cashing company 302 to the computing device 304 of the user and displayed for the user via the RCP application. The notification 326 may include information that provides the user with information as to where the user or customer may pick up cash (e.g., address location of one of the branch offices 306), that the cash was deposited in an account at a bank of the customer, or otherwise (e.g., sent via Western Union or other cash moving service). The computing device 304 may store the notification 326 as commanded by the RCP application, where the notification 326 may include a verification identifier, date, instructions, or otherwise. The user may thereafter select and display and/or print the stored notification 326 so that the user has a record of the RCP transaction.

With regard to FIG. 4, an interaction diagram showing an environment 400 in which interactions occur to enable a customer of a check cashing company to perform remote check cashing is shown. Participants for enabling remote check cashing may include an application provider 402, computing device 404 of a customer, check cashing company 406, check cashing company branch office 408, and financial institutions 410 and 412. The application provider 402 may be a software company that provides for a software application or mobile application that may be downloaded at step 414 and executed on the computing device 404 of a customer of a check cashing company 406. The RCP application being executed by the computing device 404 may provide for remote check cashing by using imaging of a paper check. The RCP app may alternatively provide for a customer to enter pertinent information of the check rather than the customer having to image the check. Although a mobile application may be executed on the computing device 404, it should be understood that rather than having to download or otherwise install a mobile application, that the computing device 404 may alternatively operate an application being executed in the “cloud” that performs the same or similar functionality as described herein. Although not shown, prior to the user utilizing the RCP app, a registration process is to be performed, as provided in FIG. 9.

With regard to FIG. 9, an electronic display 900 is shown to be displaying a screen shot of customer registration screen 902 of a remote check presentment app. The customer registration screen 902 allows the customer to enter his or her name, address, and existing customer ID if the customer already has an account with the check cashing company. In addition, if the customer has coordinates of a bank account for cash to be deposited when performing the remote check presentment capture, the customer may enter the bank account coordinates in a portion 904 of the registration screen 902. Additional information, such as password, biometric identifier (e.g., thumb print), or other identifier information may also be requested in the registration process so that the additional information may be communicated by the computing device during an RCP transaction to validate the customer. In the event that the user is not a customer, then the user may not enter an existing customer ID and one may be assigned (although other procedures to establish the user as a customer may be performed prior to the user being authorized to use the RCP app, such as visiting a storefront of a check cashing service provider).

It should be understood that the user interface may further enable a customer to enter preference information. The preference information may include settings as to whether checks are to be cashed or deposited. In one embodiment, the preference information may allow for the user to enter or select typical check makers from which the customer receives checks, and select whether those checks are to be paid out in cash or deposited. Alternatively, the user may select a date range that the checks are to be paid in cash (e.g., last five days of the month) and a date range when checks are to be deposited (e.g., up to last five days of the month). Additional and/or alternative preferences may be provided for the user to select or enter via the user interface, which may include the customer registration screen 902. It should be understood that the customer registration screen may be formed of multiple screens. Upon completion of the registration process, the customer may select a “submit” soft-button 906 for submission of the information to the check cashing company. The user interface provided in FIG. 9 is illustrative and additional and/or different information, such as “use current location to find local storefront to receive cash,” may be requested from the customer.

With further regard to FIG. 4, the customer may use the computing device 404 to image a paper financial instrument at step 416. The paper financial instrument may be a check. At step 418, the image of the financial instrument may be processed by the RCP application being executed on the computing device 404. The processing may include correcting the image for any skew, coloration, or other image processing so that text and/or images may be properly parsed and/or determined, as understood in the art. The parsing may include identifying information on the imaged financial instrument and converting the imaged information into text using character recognition, as understood in the art. From the textual information, ABA routing number, account number, check amount and any other information on the financial instrument may be determined. It should be understood that both a front and rear image of the financial instrument are required in order to capture an endorsement made by the customer and prior holders of the financial instrument. Should banking laws be altered, such endorsement capture requirement may be altered as well In addition to parsing, the RCP application may be configured to enable the user to manually adjust the check information if the parsing was incorrect or unable to convert the check image into data At step 420, an image of the financial instrument, data of the financial instrument, unique identifier of the computing device 404, customer identifier, password, or any other information may be communicated from the computing device 404 to the check cashing company 406 so as to reduce risk for the check cashing company 406 paying cash to the customer.

At step 422, the check cashing company 406, through an automated, semi-automated, or manual process, may process the image, data, and any other information using business rules. The business rules may include a wide variety of rules that assist the check cashing company 406 to validate the check, maker of the check, customer, computing device 404, and any other information to minimize risk for paying cash to the customer. For example, the check cashing company 406 may compare a password or biometric identifier that is communicated with the RCP transmission at step 420, thereby ensuring that the customer who submitted the check to be cashed is, in fact, a customer of the check cashing company 406. In one embodiment, a determination may be made as to whether the particular customer has deposited a check from that particular check maker or of a particular check at step 424, and, in response, an RCP data repository (not shown) may be updated in response to completion of the process at step 422. In updating the RCP data repository, which may be a database as understood in the art, date and time of RCP submission check image information and cash transaction information (e.g., pick up at store, deposit into account, etc.) may be added to the RCP data repository. The RCP data repository may be maintained by the check cashing company 406. Alternatively, a third-party may maintain the RCP data repository, and may be notified of RCP transactions by the check cashing company 406 so as to update the RCP data repository.

At step 426, depending on the results of the processing in step 422 of the check and check information, check image, data, and processing results may be communicated to one or more of the branch offices 408 of the check cashing company 406. The branch office(s) 408 selected to send the processing results may be determined based on “home” branch office of the customer, geographic location of the information communicated to the branch office(s) 408 may be the same for all customers or may vary based on risk potential determined by the processing performed by the check cashing company 406. For example, if the check exceeds risk thresholds (e.g., amount exceeds average check from a maker by a specified percentage), the customer may be requested or required to visit a branch office to receive cash payment. At step 428, the customer may visit the branch office 408 to receive a disbursement of money, if approved. In one embodiment, the reason for the customer having to go to the branch office 408 is as a result of risk threshold exceeding specified limits. In that event, someone at the branch office may meet with the individual to perform a manual evaluation of the customer and the check that was imaged prior to acceptance of the check.

At step 430, the branch office 408 may communicate to the check cashing company 408 that payment was tendered to the customer or that payment was denied to the customer. The payment confirmation from step 430 may be stored in an RCP database managed by or in communication with the check cashing company 406. If, however, it is determined at step 422 that the risk for payment of the cash to the customer is not a risk that exceeds a certain threshold value, then at step 432, the money may be applied to a debit instrument or deposited into an account (e.g., bank account) such that the customer does not need to visit a branch office in person. Notification that money is being added to a debit instrument or deposited into an account of the customer may also be made to the computing device 404 of the customer. The dashed lines of steps 432-436 are indicative that these steps may be optional steps depending upon the risk analysis performed at step 422.

Continuing with FIG. 4, at step 434, if the risk determined at step 422 is below a certain threshold value, then, assuming bank account information provided by the customer, then a deposit may be made by the check cashing company 406 into an account of the customer at the financial institution 410 so that the cash is immediately available to the customer for withdrawal, for use by a debit card associated with the bank account, or otherwise. Alternatively or additionally, as shown in step 434, the money may be deposited into financial institution 412, such as a brokerage house. At either step 436 or 436′, a deposit confirmation may be made from the financial institution 410 or financial institution 412, respectively, to the check cashing company 406. A transaction notification at step 438 may be given to the customer via the computing device 404 as a message in the RCP app, email, text message, or otherwise, as understood in the art.

With regard to FIG. 5, an illustration of a network environment 500 in which an RCP data repository 502 is shown to be in communication with a number of different entities, including check cashing companies, banks, retailers, and other entities that may have a need and/or desire to confirm whether or not a particular check has been cashed or otherwise tendered prior to being passed through traditional check processing operations of the traditional banking system. The RCP data repository 502, as previously described with regard to FIGS. 3 and 4, is used to store RCP data when processed by a check cashing company in response to customers performing RCP transactions. As shown, customers may utilize computing devices 504a-504n (collectively 504) that interact with check cashing companies 506a-506n (collectively 506) for performing RCP transactions. The check cashing companies 506 may be related or unrelated, where customers of each of the different check cashing companies may use the same or different RCP application on the computing devices 504. It should be understood that each customer of a check cashing company may be limited to using a single computing device for performing RCP transactions so as to avoid possible fraudulent RCP transactions. In addition to the check cashing companies 506, financial institutions 508, retailers 510, and other institutions 512, such a brokerage houses or otherwise, may be part of the environment 500 for interacting with the RCP data repository 502 for checking and clearing checks that may have been cashed or otherwise tendered by performing an RCP transaction. This RCP data repository 502 may be managed by a single check clearing company or part of a clearinghouse that supports multiple check clearing companies.

A network 514, which may be a wide area network, such as the Internet, private network, or any other communications network capable of communicating data associated with RCP transactions for communication with the RCP data repository 502, may allow for each of the organizations 506-512 to interact with the centralized or distributed RCP data repository 502. As shown, RCP information 516 may be communicated from the computing devices 504 and be acted upon by a check clearing company 506a, for example. Upon completion of the RCP transaction by the check clearing company 506a, an RCP update message 518 may be communicated to the RCP data repository 502 for storage therein. The RCP update message 518 may include RCP information that identifies the check, including check number, ABA routing number, account number, etc., unique identifier, customer, check cashing company, or any other information associated with the customer, check, and/or computing device.

Once stored in the RCP data repository 502, any institution that desires to clear a check prior to accepting or initiating processing of the check may access the RCP data repository 502 by communicating a request 520 to the RCP data repository 502 and, in response, receive a response 522 that may include a clearance indicator (e.g., no RCP transactions found for a check or RCP transaction previously made for a check) or information that indicates that the RCP data repository 502 includes information that matches the information provided to the RCP data repository. That is, the request 520 may include information that uniquely identifies a particular check, customer, unique identifier, or otherwise that may be used to search in the RCP data repository 502 to determine whether the particular check has been previously tendered using an RCP transaction. It should be understood that one reason for providing a centralized RCP data repository 502 is so that a person may not rapidly perform multiple RCP transactions or perform an RCP transaction and later (e.g., minutes or hours) pass the check for another purpose. In one embodiment, the clearinghouse or entity that manages the RCP data repository 502 may collect a subscription fee, transaction fee, or any other fee for enabling the entities to access the RCP data repository 502.

With regard to FIG. 6, a transaction diagram of an environment 600 in which communications between different entities, including an RCP data repository 602, check cashing company 604, financial institution 606, such as a bank, other financial institutions 608 (e.g., credit union), and retail/service provider 610. At step 614, the RCP data repository 602 may receive RCP data, which may include a check image and check data, and process the RCP data using business rules. The business rules may include examining the check using automated techniques for checking certain data and image(s) on a check, thereby enabling a check cashing company and/or third part that manages the RCP data repository 602 to minimize risk for cashing the check. At step 616, the RCP data repository is updated to store information indicative of the check being tendered and cashed for a specific customer and so forth, as previously described herein.

At step 618, the check cashing company 604 may, in response to receiving an RCP data submission of customer visit to a branch office, validate the check being submitted by querying the RCP data repository. Submission of information on the check to the RCP data repository 602 may be one technique used in determining whether the check is valid and has not yet been tendered for payment by the check cashing company 604 or any other check cashing company, bank, financial institution, or otherwise. At step 620, in response to a request to validate a check, the RCP data repository 602 may validate the check by using the check image, check data, customer information, or otherwise to determine whether the RCP data repository 602 has previously performed a checking request on that particular check. At step 622, the RCP data repository 602 may communicate a verification to the check cashing company 604 about the particular check being validated. The verification may be a simple Boolean response, such as true or false, which is indicative of the check having been previously tendered or not having been previously tendered. It should be understood that a variety of different verification messages may be communicated in response to a request to perform a check validation. Steps 624, 626, and 628 are validation requests and verification responses to the financial institution 606, other financial institution 608, and retailer/service provider 610, respectively. In other words, the RCP data repository 602 may become a centralized repository for performing a check clearing process by commercial entities or other check clearing processes, in accordance with the principles of the present invention. Such a centralized system may be utilized to avoid or minimize fraud as a result of having to keep up with technology and the speed at which check cashing and processing occurs these days using mobile technology.

With regard to FIG. 7, a block diagram of an illustrative computing system 700, shown here as a check cashing company server, includes a processing unit 702 that executes software 704. The processing unit 702 may be formed of one or more computer processors that are configured to execute the software 704. The software 704 may be configured to handle RCP transactions, as described herein, and manage customer information of the check cashing company. The processing unit 702 may be in communication with a memory 706 that is configured to store data and software, input/output (I/O) unit 708 that is configured to communicate data over a communications network, such as the Internet, and storage unit 710 that is configured to store one or more data repositories 712a-712n (collectively 712). The data repositories 712 may include one or more databases, flat files, or any other configuration for storing information that includes RCP transactions and information associated with the RCP transactions, as described herein. With further regard to the software 704, the software 704 may be configured to store data specifically associated with customers of the check cashing company and/or provide management for data stored in the data repositories 712 associated with customers of the check cashing company. In addition, the software 704 may be configured to store IDC transaction/information of customers not associated with the check cashing company (e.g., transactions that are performed by other check cashing companies) for storage in a centralized data repository to allow other entities to verify whether or not a check has been processed by an RCP transaction.

With regard to FIG. 8, a block diagram of an illustrative set of software modules 800 that may be used for performing RCP transactions and other management of data by the computing system 700 of FIG. 7 is shown. The software modules 800 may include a process RCP data module 802 that is configured to receive and process RCP data as customers of the check cashing company submit RCP transactions. The processing by the module 802 may include collecting and storing check image data (i.e., image of the check photographed by a computing device), check information (e.g., routing/ABA number, account number, amount of check, etc.), unique device identifier, customer information, etc. In addition, the module 802 may be configured to perform decryption if the data that is communicated to the computing system 700 from a computing device of a customer is encrypted. The module 802 may further be configured to perform a risk analysis based on customer history, maker history, image analysis, check information analysis, etc. For example, the image analysis may include comparing other check image from a particular maker of the check to compare logos, colors, layout, or any other image features of the check. Furthermore, the module 802 may be configured to perform an analysis as to whether the check information is consistent with other checks written by a particular maker to a particular customer (e.g., paychecks to this particular customer being approximately the same on a weekly basis).

An update RCP data repository module 804 may be configured to update RCP data being or to be stored in the data repository. The RCP data may include date of receipt, time of receipt, check information, check image, and any other data associated with a particular check, associated with a particular customer, and/or associated with a particular maker of a check. The RCP data may be stored in the RCP data repository so as to be searchable and accessible at another point in time In one embodiment, the module 804 may be configured to handle RCP data that is associated with one or more check cashing companies, where having the ability to handle RCP data and/or RCP transactions from multiple check cashing companies allows for the RCP data repository to be a centralized storage system for the check cashing company industry. It should also be understood that while the modules described herein are described as being associated with a check cashing company, that the modules may be configured to handle RCP data not associated with a check cashing company, but, optionally, associated with a traditional bank, retailer, or any other non-check cashing company. That is, any industry or company that processes, cashes, accepts, or otherwise participates in the usage of checks, including personal, commercial, or governmental checks, may interface with the RCP data repository to submit, verify, or clear checks before accepting or processing checks received from a third party.

A manage RCP data repository module 806 may be configured to manage RCP data being stored in the data repository. In managing the RCP data, the module 806 may be configured to automatically manage the RCP data being stored, make routine backups, allow users to view RCP data, create RCP reports automatically, semi-automatically, or manually, and so forth. The manage RCP data repository module 806 may further be configured to create and manage a mirror image copy of the RCP data repository, thereby minimizing risk of failure should a catastrophic event occur.

A process check verification requests module 808 may be configured to receive check verification requests from the check cashing company, a branch of the check cashing company, or any other organization to determine whether a particular check has been previously submitted for an RCP transaction. The module 808 may receive an entire RCP transaction, including check image, check information, unique identifier, customer information, etc., or receive a portion of check information (e.g., ABA routing number, account number, check number) so as to provide sufficient information to perform a look-up or query on the RCP data repository to determine whether a particular check has already been processed for check cashing or otherwise. The module 808 may include both back-end functionality (e.g., query operations) and a graphical user interface that enables a user to enter specific information of a check for which a customer is attempting to utilize.

A report check verifications module 810 may operate to interface with the process check verification requests module 808 and report results of a search for whether a particular check has been processed by the process RCP data module 802. In other words, a report to a request for whether a check has been processed may simply include an indication that a particular check is identified in the RCP data repository. The report or response produced by the report check verifications module 810 may also include specific information associated with an RCP transaction, including date, time, customer, or any other information associated with a check being submitted via an RCP transmission or otherwise as stored in the RCP data repository.

A customer manager module 812 may be configured to manage information associated with customers of the check cashing company, where the customer information may include name, address, bank account information, or otherwise. The customer manage module 812 may further be configured to store RCP transactions that are performed by the customers of the check cashing company, thereby maintaining a history of the customer with respect to RCP transactions. In addition, the customer manager module 812 may be configured to manage data associated with in-person transactions, where in-person transactions may include customers making check cashing transactions at a storefront of the check clearing company. Depending upon the information being managed by the customer manager module 812, risk factor metrics may also be managed by the customer manager module 812, where the risk factor metrics may include a value or grade that a customer has in terms of risk as a result of repeat business, type of checks that the customer typically cashes, or otherwise, thereby allowing the customer certain privileges when performing RCP transactions, such as having cash deposited to bank accounts, brokerage accounts, wire transfers, etc. It should be understood that the modules shown and described herein are illustrative and that additional and/or alternative modules may be utilized to provide for the same or similar functionality described herein.

With regard to FIG. 10, a flow diagram of an illustrative process 1000 for processing an RCP transaction so as to determine how and if a customer may have cash disbursed when performing an RCP transaction is shown. The process 1000 may start at step 1002, where RCP data is received from a customer using a computing device to communicate the RCP data. In one embodiment, the RCP data includes an image of a check, check information, unique identifier, and/or customer information. The RCP data may be received in an encrypted format or other security format that is created as a result of an RCP application, for example, that collects, parses, and communicates RCP data to a remote location, such as a check clearing company server.

At step 1004, a determination may be made as to whether the RCP data is being received from a customer with a positive track record or history. A positive track record may be determined based on a risk factor that a customer develops over time. For example, a customer who is making his or her first RCP transaction may have a high risk factor. As the customer performs more transactions that are proven to be successful, the risk factor of the customer may be reduced. For example, if a risk factor ranges between 0 and 100, then a risk threshold value, such as 80, may be utilized to determine that a customer has a positive;track record. If it is determined that the customer does not have a positive track record (e.g., a positive track record or risk factor above 80), then the process continues at step 1006 where cash may be conditionally made available at a storefront or branch office of a check cashing company for the customer, as further described hereinbelow.

If, at step 1004 it is determined that the customer does have a positive track record, then the process continues at step 1008, where a determination is made as to whether the check being submitted via the RCP data is from a maker with a positive track record. A determination of the maker having a positive track record may be determined from a risk factor value that ranges between 0 and 100, for example, where a risk factor value is determined based on how many times a check cashing company has received checks from the check maker, the size of the checks from the check maker, relationship with the check maker, type of entity of the check maker (e.g., governmental, large company, small company, individual), and any other factor that the check cashing company may deem to be relevant in determining whether a check maker has a positive track record. If it is determined at step 1008 that the check maker does not have a positive track record, then the process continues at step 1006, where, again, cash may be conditionally made available at the storefront for the customer that submitted the RCP transaction.

At step 1010, a determination may be made as to whether the amount from the maker is “typical” to this customer. Such a determination allows for fraudulent transactions to be caught prior to being paid out. If the determination is negative (e.g., as a result of the payment appearing beyond a certain threshold or significantly out of range from where typical payments are made to the customer by the check maker), then the process continues at step 1006, where cash is made available at a storefront of the check cashing company to the customer. At step 1012, a determination is made as to whether the customer has an established bank account with the check cashing company. If the answer is no, then the process may continue at step 1006 where cash may be conditionally made available at a storefront to the customer. It should be understood that step 1012 may be part of a determination at step 1004. However, for the purposes of this description, such a separate determination may be used

If the process 1000 reaches step 1014 as a result of each of steps 1004, 1008, 1010, and 1012 being positive, then cash may be made available at a storefront or deposited in a bank account without the customer having to visit a storefront of the check cashing company. A notice as to which storefront at which the cash is available or account in which the money is deposited may be communicated to the computing device of the customer for display thereon. It should be understood that the deposit in the bank account may alternatively be a deposit to any other account, wire transfer, or otherwise. Such alternative transactions may be determined based on the track record of the customer or risk factor associated with the customer, check maker, or any other parameter as determined by the check cashing company.

If the process reaches step 1006 where the customer is directed to a storefront, then the storefront may manually process the check and customer as understood in the art, as generally provided in steps 1018-1024. At step 1016, however, a determination may be made as to whether the customer is approved for cash receipt for the check. The approval may be made prior to the customer arriving at the store by a store manager or other employee viewing the electronic check and/or information about the customer as electronically provided by the RCP data provided at step 1002. The check cashing company may know which store the customer is going to visit and send the RCP data to the particular store. Alternatively, the RCP data may be centrally stored and downloaded by a store employee in response to an electronic or other notification that the customer is going to visit the store. If the customer is not approved for cash receipt for the check at step 1016, then the process continues at step 1018, where the physical check is received and considered for payment. In considering whether to may payment on the check, both the check and customer may be evaluated using a variety of different factors, including whether the customer is a regular customer, whether the maker of the check has provided checks to the customer in the past, whether the check is from a known maker, and so forth. If a determination is made at step 1020 to not approve the customer for payment on the check, then the process continues at step 1022 to deny payment In one embodiment, the denial of payment may be stored in a data repository associated with the customer and/or check. If at either step 1016 or 1020 approval for cash payment on the check to the customer is made, then the process continues at step 1024 and the customer is paid cash on the check.

It should be further understood that the process 1000 described herein is illustrative, and that alternative processes, conditions, or operations may be utilized in accordance with the principals of the present invention. For example, the risk assessment may be made as to the size of the check. For example, if the check is below a certain value, such as $500, then the check cashing company deems the transaction to be low risk and cash the check. If the check is above a certain value, such as $500, then the check cashing company may deem the transaction to be high risk and require the user to visit a storefront of the check cashing company. The level of risk may vary depending on the size of the check, history of the customer, history of the check maker, and so forth.

With regard to FIG. 11, an illustration of an illustrative computing device 1100, in this case a mobile telephone, that is executing a remote check presentment app and showing a response to a check presentment. The remote check presentment app may be configured to communicate an imaged check along with check items, as provided in FIG. 2, and receive a response 1102 to be presented to the customer on the computing device 1100. As shown, the response 1102 may provide an approval number 1104 (or other indicator) or denial in paying cash for the check presented via the remote check presentment app. The customer may provide the approval number 1104 to someone at a storefront. In one embodiment, a closest storefront location 1106 may be presented to the customer based on the customer's current location (e.g., using the computing device's current GPS location). In one embodiment, the remote check presentment app may provide the customer with a “request different store” soft-button 1108 to select a different store and an “OK” soft-button 1110 for the customer to acknowledge the approval response 1102. The remote check presentment app may include other graphical user interface (GUI) screens, such as a “history” GUI screen (not shown), that enables the customer to view historical check presentment transactions. The history GUI screen may show date/time submitted and date/time/location of cash received for that transaction. Alternative GUI screens may be utilized to assist the customer in performing remote check presentment activities, as well For example, if the customer is approved for bank account deposits, then a GUI screen may provide a message or a transaction record for the cash being deposited into the bank account in response to a remote check presentment transaction being approved. Such a GUI screen may also enable a customer to select and/or enter a variety of different, non-exclusive options, such as amount to be deposited in each selected account, amount to be paid in cash, amount to apply to a debt or prepaid card, and so forth.

The previous description is of a preferred embodiment for implementing the invention, and the scope of the invention should not necessarily be limited by this description. The scope of the present invention is instead defined by the following claims.

What is claimed:

1. A method of handling remote check presentment (RCP) of a check, said method comprising:
receiving, from a computing device of a user, RCP data at a computing system;
determining, by the computing system, a risk factor associated with the RCP data;
in response to determining the risk factor associated with the RCP data, determining, by the computing system, how to make cash available to the user prior to passing the check for clearance through a traditional check clearing process; and
making the cash available as determined to the user prior to passing the check for clearance through the traditional check clearing process.

2. The method according to claim 1, wherein determining a risk factor further includes determining a risk factor for the user.

3. The method according to claim 1, wherein determining a risk factor further includes determining a risk factor for a maker of the check.

4. The method according to claim 1, wherein determining a risk factor includes comparing at least one portion of an image of the check with another image and setting a risk factor value based on a result of the compared images.

5. The method according to claim 1, wherein determining a risk factor includes comparing RCP data of previous transactions by the user with a maker of the check.

6. The method according to claim 1, wherein determining how to make cash available to the user includes determining whether to limit cash being available to the user at a storefront

7. The method according to claim 1, wherein determining how to make cash available includes determining whether to deposit cash into a bank account of a user.

8. The method according to claim 1, further comprising receiving bank account coordinates for use in depositing cash from the check.

9. A system for providing remote check presentment (RCP) transaction reporting, comprising:
a storage unit configured to store a data repository that includes RCP transaction data;
a computing system in communication with said storage unit, said computing system configured to:
receive a request to query the data repository, the request including check data to compare to the RCP transaction data, the check data including information that uniquely identifies an associated check being processed or verified;
query the data repository using the check data;
determine whether the data repository includes RCP transaction data that matches the check data; and
communicating a response that indicates whether the RCP transaction data includes a match of the check data.

10. The system according to claim 9, wherein the check data includes information communicated via an RCP data transaction.

11. The system according to claim 9, wherein said computing system is further configured to provide a graphical user interface into which the check data is entered by a user to submit the check data for comparison.

12. The system according to claim 9, wherein said computing system is further configured to store the received check data in the data repository.

13. The system according to claim 12, wherein the check data includes check number, amount, routing number, and account number, and time stamp of presentment of check.

14. A method of performing remote check presentment, said method comprising:
parsing, by an application being executed by a computing device, a check image of a check to generate check data;
communicating, by the computing device, the check image to a remote location;
receiving, by the computing device, a notification of the remote check presentment being approved, and being inclusive of a storefront of a check cashing company at which money from the check can be received, and
displaying, in a graphical user interface of the application, address information of the storefront.

15. The method according to claim 14, further comprising communicating, by the computing device, information indicative of an identity of a user of the computing device.

16. The method according to claim 14, further comprising communicating a geographic location of the computing device.

17. The method according to claim 14, further comprising receiving, by the computing device, a notification of the remote check presentment being rejected, and being inclusive of a storefront of the check cashing company at which the check can be presented in person for payment.

18. The method according to claim 14, further comprising:
receiving, by the computing device, a transaction number of the remote check presentment and
displaying, by the computing device, the transaction number.
